(19) United States
(12) Patent Application Publication
(10) Pub. No.: US 2013/0151410 A1
(43) Pub. Date: Jun. 13, 2013

(54) Instant Remote Control over Payment and Cash Withdrawal Limits

(71) Applicant: René P. BÄBI, Vancouver, WA (US)

(72) Inventor: René P. BÄBI, Vancouver, WA (US)

(21) Appl. No.: 13/495,932

(22) Filed: Jun. 13, 2012

Related U.S. Application Data
(60) Provisional application No. 61/496,975, filed on Jun. 14, 2011.

(51) Int. Cl. G06Q 20/40

(52) U.S. Cl. CPC G06Q 20/409
USPC 705/44

(57) ABSTRACT

A financial transaction processing system receives a limiting instruction from an owner of an account. The limit is applied to subsequent proposed transactions involving the account, and if the limit is violated, the transaction may be declined or terminated.

### CONTINUITY AND CLAIM OF PRIORITY

This is an original U.S. patent application that claims priority to U.S. provisional application No. 61/496,975 filed 14 Jun. 2011.

### FIELD

The invention relates to financial transaction processing. More specifically, the invention relates to methods for users (consumers) to control the limits or boundaries of transactions to which they are a party.

### BACKGROUND

The U.S. banking system operates using protocols developed, refined and tested over decades, and its continued viability is a testament to the vision and skill of its designers. However, advances in the communication and computation resources available to the general public, and the growing number of situations in which parties wish to enter financial transactions, have exposed a number of shortcomings of the traditional transaction clearing system. The system still protects many of the important parties: banks and processors, but consumers and merchants are increasingly exposed to risks that are difficult or impossible for them to mitigate.

As an example of the increased risks, consider that consumers' information is stored in many more locations than it was in earlier decades, and the storage locations—often electronic—are much more easily accessed by a wider range of people. This information may not be a complete record of the person, but between the pieces available, it is often possible to cobble together enough information to commit identity fraud. And second, card-not-present transactions have become commonplace, so a fraudster with a credit card number and a little information about a person is often able to make purchases. If these fraudulent purchases are discovered, the consumer may be able to disavow them, but the loss is then borne by the merchant, and in any case, the clean-up is inconvenient and time-consuming for the consumer.

Systems and methods to help consumers and merchants protect themselves from fraudulent transactions may be of significant value in this field.

### BRIEF DESCRIPTION OF DRAWINGS

Embodiments of the invention are illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

FIGS. 1A and 1B outline registration, payment and clearing operations according to an embodiment of the invention.

FIG. 2 outlines conventional payment processing.

FIG. 3 provides greater detail on operations of an embodiment.

FIG. 4 shows an optional sequence of operations that may be performed in some embodiments.

### DETAILED DESCRIPTION

Embodiments of the invention place a user control that can be adjusted in real time, either interactively or programmatically, into the payment loop. This control allows a transaction to be trapped and checked or aborted, before it goes into the standard banking system (where batch processing may grant a fraudster a significant time delay to hide his trail or otherwise get away with a phony charge).

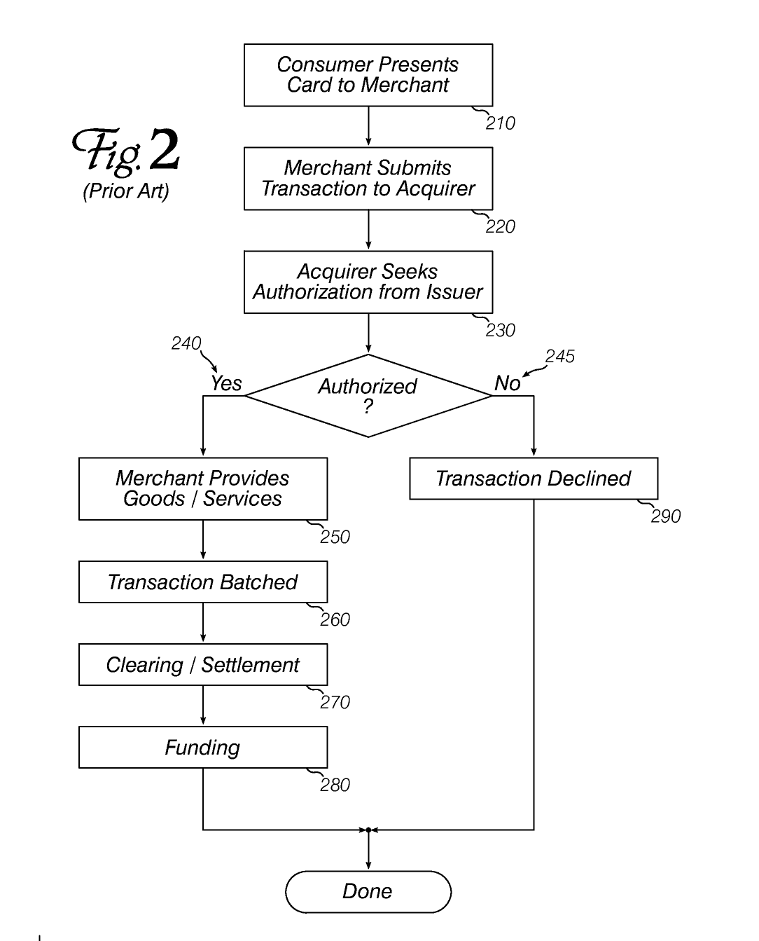

FIG. 2 outlines the conventional process of making a purchase with a credit card. Many details are omitted, since they are well-known in the art and do not contribute to an understanding of the present invention. The process starts when a consumer presents his card to a merchant (210). This may be done in person, while the consumer is visiting a store or restaurant; or by reading the credit card number over the phone or entering it into a website operated by the merchant. The merchant manually or automatically submits transaction information (e.g. , merchant identification, transaction amount, type of goods or services, etc.) to the acquirer (220). The acquirer is an entity that assists the merchant in processing card charges, and it will eventually accept money for the transaction on the merchant's behalf

The acquirer may perform some checks of its own on the transaction, but will eventually seek authorization for the transaction from the issuer (230). The issuer is a bank or bank-like entity that issued the card to the cardholder. In response to the acquirer's inquiry, the issuer will determine whether to authorize the transaction. For example, the issuer may check whether the card has been reported lost or stolen, whether the transaction would exceed the consumer's credit limit, etc. If the transaction is authorized (240), notice will be returned to the merchant, which provides the requested goods or services (250). Thereafter, several other events occur (mostly asynchronously): the authorized transaction is “batched” with others (260) and processed through a clearing & settlement process (270) so that the merchant will eventually receive its money (280). (If the issuer determines that the transaction should not go through (245), it will decline the authorization request (290) and the consumer will have to find another way to pay for the transaction.)

As explained earlier, this conventional process is reliable and proven, but it does not offer a consumer any control beyond simply deciding not to present his credit card to initiate a transaction. And, although laws and policies may protect the consumer from straight-up fraud (i.e., unauthorized use of his card accounts by someone who illicitly acquires the information necessary to make transactions), there are many scenarios where the card-user's authorization may be less clear, and where the cardholder may benefit from greater control. For example, a parent may wish to allow a child to make certain purchases, from certain vendors or of predetermined goods, but only at selected times. Or an employer may wish to allow an employee to use a company credit card for some purchases, but not for others. Embodiments of the invention support placing arbitrarily complex limits on the use of a credit card account.

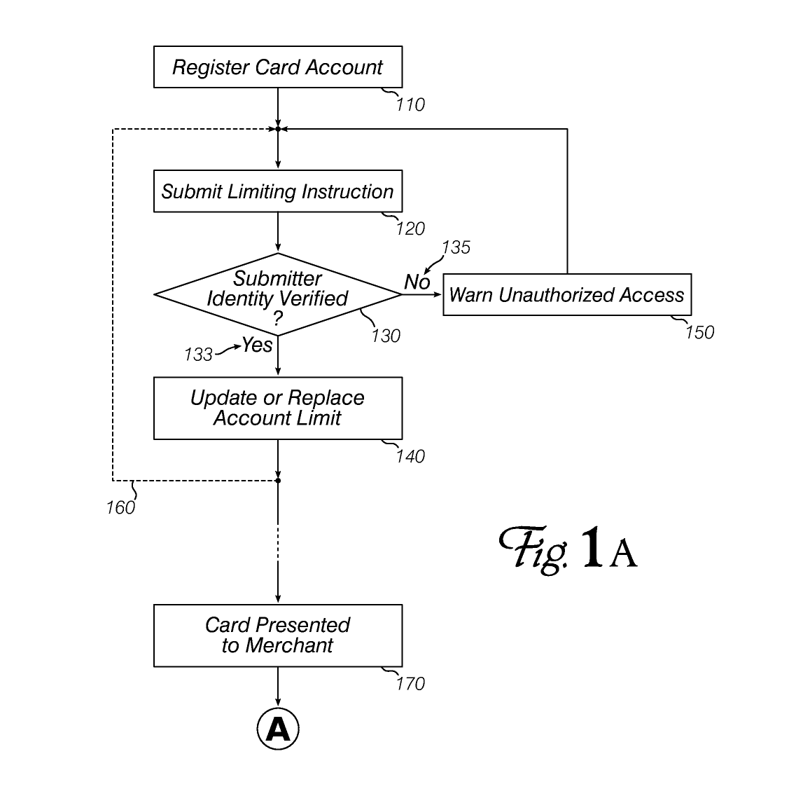

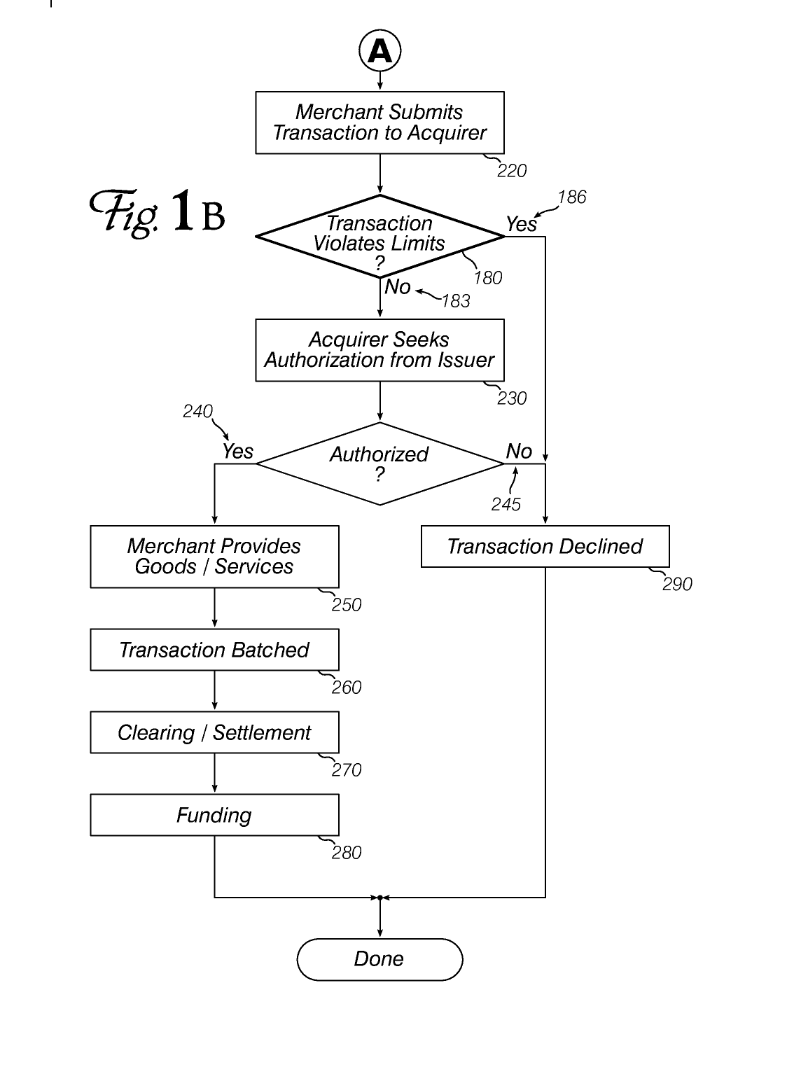

FIGS. 1A and 1B outline operations according to an embodiment of the invention. After some initial setup, embodiments make small but significant changes to the standard payment processing sequence, although the overall effect of the sequence is the same: a consumer is able to use his credit card to purchase something from a merchant.

To take advantage of the invention, a cardholder first registers his account with the operator of an embodiment (110). The operator may request (or require) any sort of information from the cardholder, but an embodiment only needs: (a) a reliable way to receive messages from the cardholder; (b) a way to associate the cardholder with the registered account; and optionally (c) a bidirectional way to communicate with the cardholder.

Once registered (or during registration), the cardholder sends a limiting instruction to be recorded by the embodiment operator (120). The operator should verify that the instruction really came from the cardholder (or another authorized person), using some of the information collected during enrollment (130). If it did (133), a limit or set of limits associated with the account will be updated (140). If the instruction cannot be verified (136), the operator may wish to warn the cardholder about the apparent attempt at unauthorized limit-setting (150). From time to time, the cardholder may change the limits (dashed line 160).

Later, the card is presented to a merchant as payment for goods or services (170). The card will often be presented by the cardholder, but it may be presented by an authorized or even an unauthorized third party. Continuing into FIG. 1B, the merchant sends the proposed transaction to its acquirer for authorization (220). However, before proceeding conventionally, the acquirer checks to see whether the transaction would violate a limit set by the cardholder (180). This check may be performed by the acquirer itself (i.e., if the acquirer is operating the embodiment) or by a third party. If the transaction would not violate a limit (183), then it is passed to the issuer for authorization (230) and the remaining conventional operations occur to approve or deny the transaction, etc. However, if the transaction would violate a limit set by the cardholder (186), then the transaction may be declined (290), just as if the issuer had refused authorization for reasons of its own (e.g., suspected fraud, credit limit exceeded, and so on.)

Several points should be noted in considering this flow chart: first, the limit that is checked at 180 is set by the cardholder, not by another participant in the method (such as the merchant, acquirer or issuing bank). Second, the cardholder-set limit can only restrict the transactions that can occur. The cardholder cannot, for example, approve and force to occur a transaction that would exceed his credit limit. Third, the limit check can be performed by any (or all) of the merchant, acquirer or issuer, although for greatest generality and ease of implementation, it is preferred that either the acquirer or issuer perform the check. Customer-specified limit checks can also be performed after the issuer's own checks. An embodiment can be implemented by an entity that serves as a proxy for another participant in the credit card clearing process. For example, a proxy acquirer could accept authorization requests from merchants and compare them with cardholder-set limits before forwarding the requests to the conventional acquirer for ordinary processing. Or a proxy issuer could accept requests from acquirers and check them before forwarding them to the real issuer. In these and similar proxy situations, the operator of an embodiment would pass the request and response along without modification, except when a limit was violated. In the latter event, the request could be declined without consulting the proxied service.

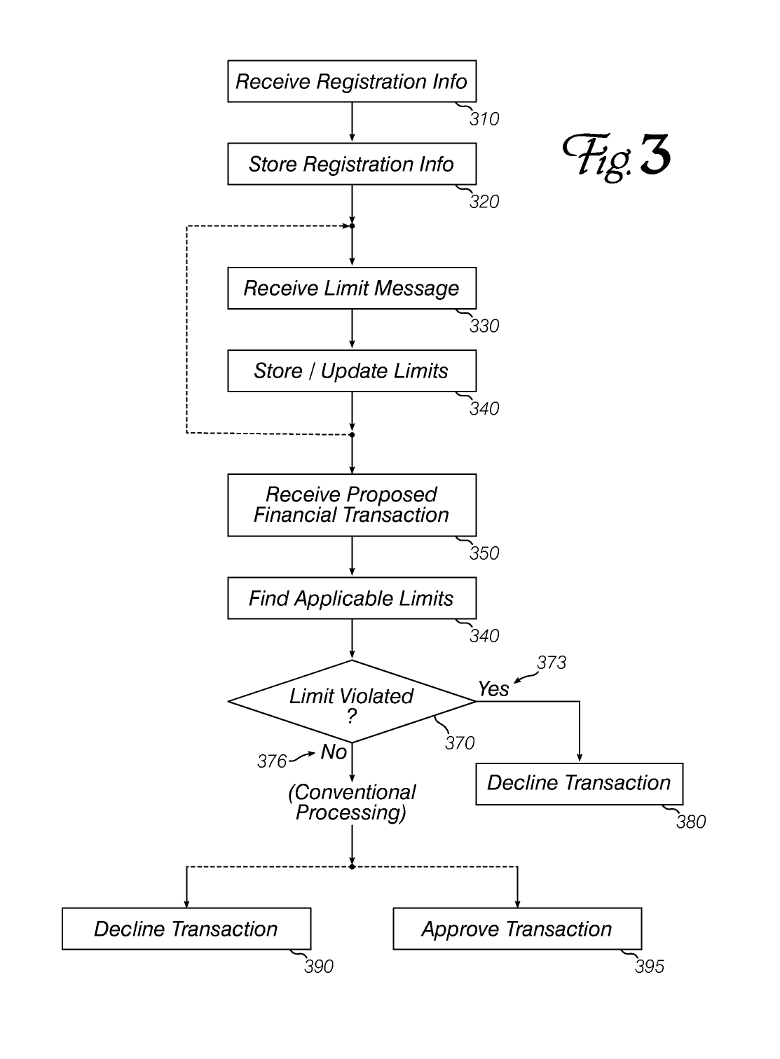

FIG. 3 illustrates the activities of the operator of an embodiment in greater detail. First, registration information is received from a credit card account holder (310), the information including at least that sufficient to authenticate messages from the account holder and identify the credit card account. In some embodiments, the cardholder's cell phone may be used for communication and authentication (i.e., messages transmitted from the cell phone, perhaps augmented with a password or personal identification number [“PIN”], are treated as genuine; and the same phone may be used for interactive operations, as discussed below). This information is stored in a database (320).

After registration, a message comprising a limiting instruction is received from the account holder (330) and stored in a database (340). (The databases need not be the same, but there must be a way to associate or correlate the various pieces of information, such as the cardholder identity, card account, and active limits.) These steps may be repeated from time to time, as the cardholder decides to raise, lower or otherwise modify the limits.

Now, the operator of the embodiment receives notice of a proposed financial transaction involving the credit card account (350). This notice may come, for example, from a merchant to whom the card has been presented, or an acquirer that is seeking authorization for a charge on behalf of the merchant. The database(s) is/are reviewed to find cardholder-specified limits that are presently in effect for the card account identified in the proposed transaction (360), and the transaction is examined to determine whether any of the limits would disallow it (370). If a limit is violated (373), then the operator sends a reply to the requester or proposer of the transaction, declining the transaction (380). If no limit is violated (376), then the proposed transaction is passed to conventional authorization processes which may decline it (390) (for example, if the amount exceeds the available credit limit); or approve it (395) for execution.

Embodiments of the invention may support a variety of different limits, from simple transaction-amount filters (e.g., “decline any transaction in excess of $100”) to time-based filters (e.g., “decline transactions proposed outside 9:00 A.M. to 5:00 P.M. on weekdays”) and geographical or physical-location filters (e.g., “decline transactions outside Los Angeles,” or “decline transactions less than 700 miles from the previous transaction.”) Some embodiments may support combinations of limits using, for example, Boolean operators: “decline transactions matching Condition A OR Condition B AND NOT Condition C.” Other embodiments may incorporate automatic time- or condition-based limit setting. For example, a “temporary limit” instruction may raise a transaction amount limit for a predetermined period of time, or until the next transaction occurs. Then the limit may be automatically returned to its previous stage. (A fail-safe mechanism might automatically restore the previous limit after a system-specified maximum delay elapses, to prevent a “temporary” limit from remaining in effect much longer than intended.) The following paragraphs offer example limits that may be appropriate for particular situations.

A parent may allow her child to use her credit card, but set limits on time (not during school hours), merchandise (food or clothes, but not alcohol or travel), or location (only within 5 miles of home or school).

A trucking company may allow its drivers to use company credit cards to purchase fuel, but only at selected filling stations, or no more often than a previous fuel purchase could be consumed by traveling over the driver's scheduled route, or no less than 1,000 miles from the previous fill-up.

A cardholder can use an embodiment of the invention to help protect against identity theft and fraudulent charges. As noted above, statutes and account agreements frequently offer ultimate nonliability for such charges, but the cardholder is still exposed to some expense and considerable inconvenience in recovering from an episode of identity theft. However, by setting a low (or zero) transaction amount limit, he may arbitrage the cost: by setting a zero limit, a thief will be unable to initiate charges, but the cardholder will be inconvenienced by having to raise the limit before every legitimate purchase (and lower it afterward, unless an auto-lowering embodiment is in use). A modest limit, chosen to split the difference between zero and the liquidated cost of cleaning up after an episode of fraudulent use, allows the cardholder to permit a limited amount of unauthorized or criminal use, without risking the full amount of his credit limit.

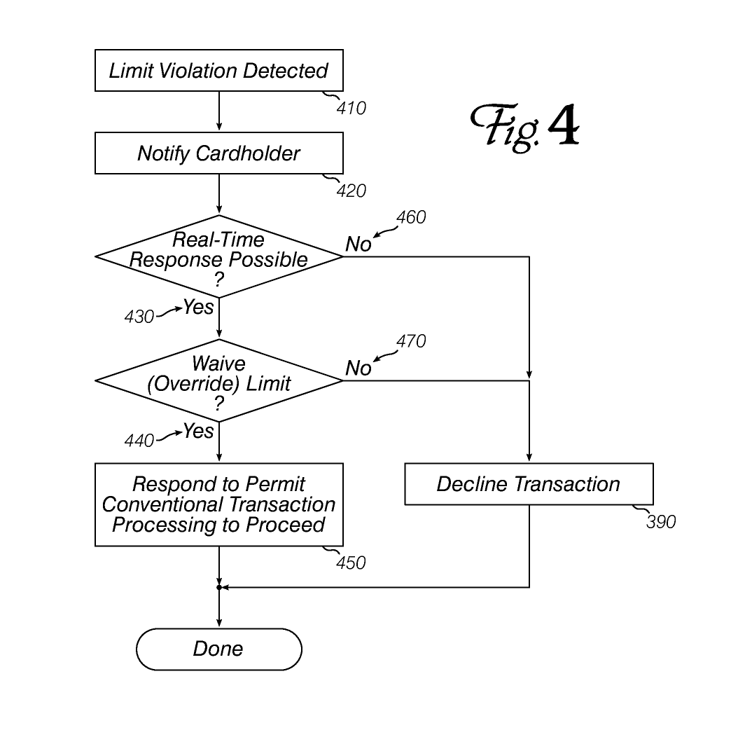

In some embodiments, detection of a violated limit may trigger further activity, rather than simply returning “transaction declined.” FIG. 4 outlines this activity: at 410, a proposed financial transaction is found to violate a limit set by the cardholder. The operator of this embodiment uses information collected during account registration to notify the cardholder in real time (420), and if the cardholder can be reached by a two-way communication channel (430), he may be offered the opportunity to override the limit. For example, upon detecting that a transaction would violate a limit, a text message or automatic voice call may be placed to the cardholder's phone. The message may detail the transaction and allow the user to provide overriding authorization for the transaction to proceed. If the user decides to override the limit (440), then the embodiment responds so as to permit conventional transaction processing to continue (450). If the user does not override the limit (470), or cannot be contacted via a two-way channel (460), then the transaction is declined (390). (Again, note that the user's ad hoc authorization cannot override any subsequent checks or limits imposed by the issuer or others involved in the transaction; it merely allows the cardholder to waive limits he himself set.)

The methods described above enable the user, via their mobile phone, to instantly control how much money is available for use for a purchase and/or ATM or kiosk withdrawal transaction. A transaction for any amount exceeding a set limit may cause an instant denial of the transaction. The user, through a secure method on their cell phone, can instantly adjust the limits up or clown while standing at a POS register or ATM or financial kiosk machine. The user can keep the limit set low until he/she needs to perform a transaction, then adjust the limit for the transaction amount (or higher). After a transaction is successfully completed, the system may automatically adjust the limit clown to the original low limit set by the user prior to the transaction.

The user has the option of letting the system maintain a running balance (the limit set by the user less the transaction amounts). In other words, one limit that the user can set may be a transaction limit: no new, single transactions larger than $X will be allowed (although the running balance may be greater than $X). The user also has the option of re-setting the limit back up to the original limit after transactions have reduced the available balance (much like a reload of a debit account).

In many embodiments, the user gets a transaction notification on their cell phone via text message, email, or any other then-available means of the details of the attempted or successful transaction, the limit then in effect, and any associated balance available.

Payment and cash withdrawal instruments are defined herein as:

1) Debit and Credit Cards,

2) Debit and Credit Accounts,

3) Line of Credit, checking accounts, and ACH transactions, and

4) Virtual and mobile phone card and bank accounts

### How the Fraud Prevention Method Works:

### Registration:

A user connects to a web site, data phone application or IVR system, or calls a customer service center to subscribe to use of the “set limit” service. This service will ask the user to provide the full card, checking, or virtual account number of each account the user wants to register for protection under the “set limit” service. The user must also provide the correct registered address associated with each account. Lastly, the system will ask the user to enter their cell phone number. To validate the cell phone number that will be associated with the accounts being registered under the “set limits” service, the system will send to that cell phone number a unique (text, email, or otherwise) with a unique “password” that the user must then enter on their cell phone keypad and send back to the system.

The system will receive the correct “password” associated with the cell phone number. Then the system will ping the accounts for a minimum purchase to test the validity of the accounts and the associated addresses. When the accounts are validated, they will be included in a database that is interconnected to the payment and transaction processing networks such as Star, First Data, Elan, Pulse, Visa, MasterCard, etc. At this point, registration is complete.

### Set Limits:

The user accesses the system with their cell phone (using the registered ANI) by dialing in to the system database (dialing the DNIS connected to the database). The system will use the incoming cell phone address (the Automatic Number Identification or “ANI”) to establish the connection to the user file in the system. A password will then be required to be entered from the user's cell phone to validate that the legitimate user is accessing the system. If the user has registered more than one account or card number, he/she will then be required to enter the last four digits of the account or card number. This completes the validation process. This process for the user should be no longer than 6 to 10 seconds using a speed dial for the DNIS.

The user then enters the desired upper limit for that account or card. The upper limit can be any number, including a minimum number greater than zero. The system then enters this value into its database against that account or card number. The same process is used to alter any set limits. Any limit set cannot over-ride, invalidate, or alter any prior limits set by the issuing financial organization. For example, if a debit card had a bank limit of $500 set on a POS transaction, then if a user set their limit to be $600, and a POS transaction of $550 came in to the payment and transaction processing network, it would pass the $600 limit, and be sent on to the card issuing bank, which would then reject the transaction because it exceeded the bank's set limit.

### System Operation:

Almost all on-line and POS purchases, as well as ATM withdrawal transactions are sent to processing networks to a processor to conduct the transaction. That processor will identify incoming transactions that are of specific types needed by the set limits service. The processor then checks to see if any of the incoming card BIN (bank ID number) or account routing number, or virtual account identifier is registered with the set limits service. If not, the transaction passes. If it is registered, the entire number is passed to, and screened by the set limits system to see if the account is resident in the set limits database. If not, the transaction passes. If it is, then the amount of the transaction is compared to the limit amount (or remaining balance from a prior limit) set for that account number. If the transaction is equal to or within the limit, it passes back to the processor as a good transaction. If it is above the limit or available balance, then the system passes back to the processor a transaction denial message for insufficient funds. The transaction attempt is logged and reported to the associated cell phone number as a failed attempt.

In the case of the user having opted for a running balance method, then the system may works as follows: if the initial limit is set at $100, and a transaction of $40 is passed, the balance will be $60. Then when a second transaction of $40 is made, it passes too, and the balance is $20. The next attempt at a $40 transaction will be denied. At any time, the user can set the limit back up to the original $100 amount, or set a new limit, and may keep the running balance feature or not.

An embodiment of the invention may be a machine-readable medium having stored thereon data and instructions to cause a programmable processor to perform operations as described above. In other embodiments, the operations might be performed by specific hardware components that contain hardwired logic. Those operations might alternatively be performed by any combination of programmed computer components and custom hardware components.

Instructions for a programmable processor may be stored in a form that is directly executable by the processor (“object” or “executable” form), or the instructions may be stored in a human-readable text form called “source code” that can be automatically processed by a development tool commonly known as a “compiler” to produce executable code. Instructions may also be specified as a difference or “delta” from a predetermined version of a basic source code. The delta (also called a “patch”) can be used to prepare instructions to implement an embodiment of the invention, starting with a commonly-available source code package that does not contain an embodiment.

In some embodiments, the instructions for a programmable processor may be treated as data and used to modulate a carrier signal, which can subsequently be sent to a remote receiver, where the signal is demodulated to recover the instructions, and the instructions are executed to implement the methods of an embodiment at the remote receiver. In the vernacular, such modulation and transmission are known as “serving” the instructions, while receiving and demodulating are often called “downloading.” In other words, one embodiment “serves” (i.e., encodes and sends) the instructions of an embodiment to a client, often over a distributed data network like the Internet. The instructions thus transmitted can be saved on a hard disk or other data storage device at the receiver to create another embodiment of the invention, meeting the description of a machine-readable medium storing data and instructions to perform some of the operations discussed above. Compiling (if necessary) and executing such an embodiment at the receiver may result in the receiver performing operations according to a third embodiment.

In the preceding description, numerous details were set forth. It will be apparent, however, to one skilled in the art, that the present invention may be practiced without some of these specific details. In some instances, well-known structures and devices are shown in block diagram form, rather than in detail, in order to avoid obscuring the present invention.

Some portions of the detailed descriptions may have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the preceding discussion, it is appreciated that throughout the description, discussions utilizing terms such as “processing” or “computing” or “calculating” or “determining” or “displaying” or the like, refer to the action and processes of a computer system or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, including without limitation any type of disk including floppy disks, optical disks, compact disc read-only memory (“CD-ROM”), and magnetic-optical disks, read-only memories (ROMs), random access memories (RAMs), eraseable, programmable read-only memories (“EPROMs”), electrically-eraseable read-only memories (“EEPROMs”), magnetic or optical cards, or any type of media suitable for storing computer instructions.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will be recited in the claims below. In addition, the present invention is not described with reference to any particular programming language. It will be appreciated that a variety of programming languages may be used to implement the teachings of the invention as described herein.

The applications of the present invention have been described largely by reference to specific examples and in terms of particular allocations of functionality to certain hardware and/or software components. However, those of skill in the art will recognize that flexible control over financial transaction authorization can also be produced by software and hardware that distribute the functions of embodiments of this invention differently than herein described. Such variations and implementations are understood to be captured according to the following claims.

I claim:

1. A method for adjusting a transaction limit for a credit or debit card transaction comprising:
registering a cell phone to be associated with a credit or debit account;
receiving a transaction limit for the credit or debit account from the cell phone;
receiving an attempted transaction affecting the credit or debit account;
comparing a value of the attempted transaction to the transaction limit; and
if the value is lower than the transaction limit, then approving the attempted transaction, or
if the value is higher than the transaction limit, then declining the attempted transaction and sending a notification to the cell phone.

2. The method of claim 1 wherein the transaction limit is a first transaction limit, the method further comprising:
receiving a second, temporary transaction limit for the credit or debit account from the cell phone, said second, temporary transaction limit received after the first transaction limit; and
restoring the first transaction limit after the receiving and comparing operations, wherein
comparing the value of the attempted transaction is comparing the value of the attempted transaction to the second, temporary transaction limit.

3. The method of claim 2, further comprising:
restoring the first transaction limit before the receiving and comparing operations if a predetermined period of time elapses before the receiving an attempted transaction operation occurs.

4. The method of claim 1 wherein receiving the transaction limit for the credit or debit account from the cell phone comprises:
validating an Automatic Number Identification (“ANI”) number of the cell phone against an authorized ANI obtained during the registering operation.

5. The method of claim 1 wherein receiving the transaction limit for the credit or debit account from the cell phone comprises:
validating a Personal Identification Number (“PIN”) submitted with the transaction limit against an authorized PIN obtained during the registering operation.

6. A method for authorizing a financial transaction comprising:
receiving registration information from a credit card account holder, said registration information sufficient to authenticate the credit card account holder and to identify the credit card account, and storing the registration information in a database;
receiving a limiting instruction from the credit card account holder and storing the limiting instruction;
receiving notice of a proposed financial transaction involving the credit card account;
comparing the proposed financial transaction with the limiting instruction; and
if the proposed financial transaction is disallowed by the limiting instruction, sending a reply to decline the proposed financial transaction.

7. The method of claim 6, further comprising:
comparing the proposed financial transaction with a limit not set by the credit card account holder; and
if the proposed financial transaction is disallowed by the limit not set by the credit card account holder, sending a reply to decline the proposed financial transaction.

8. The method of claim 6, further comprising:
if the proposed financial transaction is allowed by the limiting instruction, sending notice of the proposed financial transaction to a proxied transaction processor;
receiving a response from the proxied transaction processor, the response to indicate whether the proxied transaction processor accepted or declined the proposed financial transaction; and
forwarding the response from the proxied transaction processor to the entity from which notice of the proposed financial transaction was received.

9. A computer-readable medium containing data and instructions to cause a programmable processor to perform operations comprising:
receiving information about a proposed financial transaction, said information including a transaction amount, a merchant identification, identification of goods, and an account identification;
retrieving at least one limit associated with the identified account from a database, said at least one limit controlled by an owner of the identified account;
comparing the transaction with the at least one limit to determine whether the transaction violates the at least one limit; and
if the transaction violates the at least one limit, returning a response to decline the transaction.

10. The computer-readable medium of claim 9 wherein the comparing operation is to compare an amount of the transaction with a maximum amount specified by the limit.

11. The computer-readable medium of claim 9 wherein the comparing operation is to compare a geographical location of the transaction with an inclusion range specified by the limit, and detect a violation if the geographical location is outside the inclusion range.

12. The computer-readable medium of claim 9 wherein the comparing operation is to compare a geographical location of the transaction with an exclusion range specified by the limit, and detect a violation if the geographical location is within the exclusion range.

13. The computer-readable medium of claim 9 wherein the comparing operation is to compare a time of the transaction with an allowable time range specified by the limit, and detect a violation if the time of the transaction is outside the allowable time range.

14. The computer-readable medium of claim 9 wherein the comparing operation is to compare a product to be purchased in the transaction with a set of allowable products specified by the limit, and detect a violation if the product to be purchased is not among the set of allowable products.

15. The computer-readable medium of claim 9 wherein the comparing operation is to compare a product to be purchased in the transaction with a set of excluded products specified by the limit, and detect a violation if the product to be purchased is among the set of excluded products.

16. The computer-readable medium of claim 9 wherein the comparing operation is to compare a first geographical location of the transaction with a second geographical location of a previous transaction, and to detect a violation if a distance between the first geographical location and the second geographical location is smaller than a predetermined distance set by the limit.

17. The computer-readable medium of claim 9 wherein the comparing operation is to compare a first time of the transaction with a second time of a previous transaction, and to detect a violation if a delay between the first time and the second time is shorter than a predetermined period set by the limit.

18. The computer-readable medium of claim 9, containing additional data and instructions to cause the programmable processor to perform operations comprising:
sending notification of the transaction violating the at least one limit to a cell phone of the owner of the identified account.

19. The computer-readable medium of claim 18, containing additional data and instructions to cause the programmable processor to perform operations comprising:
receiving a message from the cell phone of the owner of the identified account after sending notification of the transaction violating the at least one limit; and
changing an outcome of the comparing operation from “violation” to “no violation.”
